(19) United States
(12) Patent Application Publication
(10) Pub. No.: US 2014/0032057 A1
(43) Pub. Date: Jan. 30, 2014

(54) FEEDFORWARD CONTROL SYSTEM

(71) Applicants: Wei Li, Peoria, IL (US); Brian Douglas Hoff, East Peoria, IL (US); Kevin M. Moloney, Washington, IL (US); Mark Edward Rettig, East Peoria, IL (US); Corey Lee Gorman, Tarumi-ku (JP)

(72) Inventors: Wei Li, Peoria, IL (US); Brian Douglas Hoff, East Peoria, IL (US); Kevin M. Moloney, Washington, IL (US); Mark Edward Rettig, East Peoria, IL (US); Corey Lee Gorman, Tarumi-ku (JP)

(21) Appl. No.: 13/556,675

(22) Filed: Jul. 24, 2012

(51) Int. Cl. B60W 10/06; B60W 10/30

(52) U.S. Cl. 701/50

(57) ABSTRACT

A method of controlling a machine power source includes receiving a request indicative of desired machine implement movement. The desired movement will require a corresponding change in loading on a hydraulic pump. The method also includes determining a steady state torque required for the request, and determining a transient torque required for the request. The transient torque is based on a desired rate of implement movement associated with the request. The method further includes generating a power source fueling signal corresponding to a total torque required for the change in loading on the pump, and providing fuel to the power source based on the fueling signal prior to transmission of the change in loading on the pump to the power source.

### TECHNICAL FIELD

The present disclosure relates generally to a control system and, more particularly, to a feedforward control system.

### BACKGROUND

Machines such as, for example, wheel loaders, track type tractors, and other types of heavy machinery can be used for a variety of tasks. These machines include a power source, which may be, for example, an engine, such as a diesel engine, gasoline engine, or natural gas engine that provides the power required to complete such tasks. To effectively perform such tasks, the machines also include one or more implements, and at least one hydraulic pump driven by the power source. The hydraulic pump is typically fluidly connected to one or more hydraulic cylinders associated with each implement, and movement of each implement can be controlled by directing hydraulic fluid to and/or removing hydraulic fluid from such cylinders.

Ideally, the power source may be operated with a relatively constant torque and speed, and such a relatively constant power source torque and speed should result in relatively low fuel consumption and relatively smooth machine operation. However, changes in loading on the hydraulic pump during performance of the tasks described above are often unpredictable and cannot always be controlled. Since the hydraulic pump is driven by the power source, such changes in loading on the hydraulic pump are transmitted to the power source. These changes in loading can adversely affect power source performance.

For example, when a load is suddenly applied to the hydraulic pump via one of the implements, the hydraulic pump will draw extra mechanical power from the power source. In order to provide such extra power, the power source must draw in extra combustion air and extra fuel. Similarly, when a load is suddenly removed from the hydraulic pump via the implement, the pump will draw less mechanical power from the power source and the power source must quickly respond by drawing in less combustion air and fuel.

Although the hydraulic pump may respond quickly to the changes in load, the power source may have a much slower response time. This slower response time may be due to a variety of factors including a mechanical delay associated with the combustion process, and an electronic delay associated with generating and providing a fueling signal to components of the power source. As a result of an increase in loading on the hydraulic pump, and due to the relatively slower response of the power source, the power source may lug (i.e., the speed of the power source may slow as a torque load increases) until the additional fuel and air can be directed into the power source and the power source can begin producing the higher output of mechanical power required by the hydraulic pump. Similarly, as a result of a decrease in loading on the hydraulic pump, and because of the relatively slower response of the power source, the power source may overspeed until the fuel and air directed into the power source can be reduced. Power source lugging or overspeeding can cause machine performance to fluctuate undesirably.

Historically, attempts to smooth fluctuations in the performance characteristics of a machine have included feedforward fueling of the power source. Specifically, if changes in hydraulic pump loading can be sensed quickly, a fueling signal indicative of an impending mechanical load change can be directed to the power source before that mechanical load change can cause the power source to operate undesirably. In this manner, the power source can be given time to respond to the impending mechanical load change prior to transmission of the change in loading on the hydraulic pump to the power source (i.e., prior to the mechanical load on the power source actually changing). This feedforward fueling may help reduce a magnitude of power source lugging or overspeeding as a result of the mechanical load change.

One attempt to provide feedforward control is disclosed in U.S. Pat. No. 7,098,628 (the '628 patent). In particular, the '628 patent discloses a generator control system for a vehicle that includes an AC generator driven by an engine, a load current detector, a driving-torque-increase calculator, a field current control means, and an engine power adjusting means. During operation, the driving-torque-increase calculator calculates a predicted increase in driving torque required from the engine by the AC generator to provide for an increase in the current supplied to an electric load as detected by the load current detector. When the predicted increase in driving torque is greater than a predetermined value, the engine power adjusting means adjusts engine power according to the predicted increase. While engine power is being adjusted, the field current control means limits an increase rate of the generator's field current within a predetermined value. By limiting the field current during adjustment of engine power, the likelihood of engine lugging or overspeeding may be reduced.

Although the '628 patent may help reduce the likelihood of engine lugging or overspeeding, the system may not be effective in a variety of situations. For example, because the control system only limits an increase rate of the generator's field current when the increase is greater than a predetermined value, the system may not be responsive to relatively rapid (i.e., transient) fluctuations in loading at the motor.

The disclosed systems and methods are directed to overcoming one or more of the problems set forth above and/or other problems of the prior art.

### SUMMARY OF THE INVENTION

In an exemplary embodiment of the present disclosure, a method of controlling a power source of a machine having an implement includes receiving a request from an operator of the machine indicative of a desired movement of the implement. The desired movement will require a corresponding change in loading on a hydraulic pump associated with the implement. The method also includes determining a steady state torque that will be required to satisfy the request, and determining a transient torque that will be required to satisfy the request. The transient torque is based on a desired rate of implement movement associated with the request. The method further includes generating a power source fueling signal based on the steady state torque and the transient torque. The fueling signal corresponds to a total torque required to satisfy the change in loading on the hydraulic pump. The method also includes providing fuel to the power source based on the fueling signal prior to transmission of the change in loading on the hydraulic pump to the power source.

In another exemplary embodiment of the present disclosure, a method of controlling a power source of a machine having an implement includes determining a plurality of operating characteristics of the machine in a closed-loop manner. The plurality of operating characteristics includes a desired rate of implement movement and a corresponding change in loading on a hydraulic pump associated with the implement. The method also includes determining, based on the plurality of operating characteristics, that at least one of implement lift and implement tilt is desired by an operator of the machine. The method further includes determining a steady state torque and a transient torque corresponding to the desired at least one of implement lift and implement tilt. The transient torque is determined based on the desired rate of implement movement. The method further includes determining, based on the steady state torque and the transient torque, a total torque required to satisfy the change in loading on the hydraulic pump. The method also includes providing fuel to the power source based on the determined total torque prior to transmission of the change in loading on the hydraulic pump to the power source.

In a further exemplary embodiment of the present disclosure, a machine includes a power source, an implement, and a hydraulic pump driven by the power source and operably connected to the implement. The machine also includes a controller in communication with the power source and the hydraulic pump. The controller is configured to receive a request from an operator of the machine indicative of a desired movement of the implement. The desired movement will require a corresponding change in loading on the hydraulic pump. The controller is also configured to determine a steady state torque that will be required to satisfy the request, and to determine a transient torque that will be required to satisfy the request. The transient torque is based on a desired rate of implement movement associated with the request. The controller is further configured to determine, based on the steady state torque and the transient torque, a total torque required to satisfy the change in loading on the hydraulic pump. The controller is also configured to modify power source fueling, based on the total torque, prior to transmission of the change in loading on the hydraulic pump to the power source.

### BRIEF DESCRIPTION OF THE DRAWINGS

FIG. 1 illustrates an exemplary machine of the present disclosure.

FIG. 2 illustrates an exemplary hydraulic control system of the machine illustrated in FIG. 1.

FIG. 3 is a flowchart illustrating an exemplary method of control that may be used in conjunction with the machine of FIG. 1.

FIG. 4 is a graph illustrating an exemplary relationship between power source torque and time.

### DETAILED DESCRIPTION

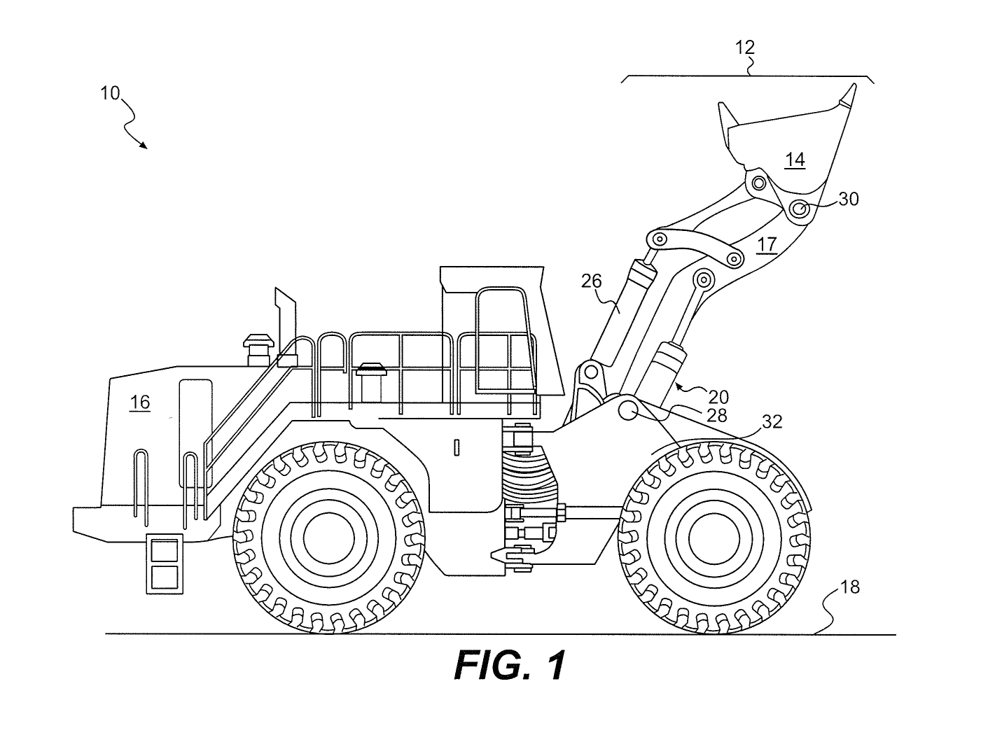

FIG. 1 illustrates an exemplary machine 10 having multiple systems and components that cooperate to accomplish a task. Machine 10 may embody a fixed or mobile machine that performs some type of operation associated with an industry such as mining, construction, farming, transportation, or another industry known in the art. For example, machine 10 may be a material moving machine such as the loader depicted in FIG. 1. Alternatively, machine 10 could embody an excavator, a dozer, a backhoe, a motor grader, or another similar machine. Machine 10 may include, among other things, a linkage system 12 configured to move an implement 14, and a power source 16 that provides power to linkage system 12.

Linkage system 12 may include one or more structures acted on by corresponding fluid actuators to move implement 14. Specifically, linkage system 12 may include a boom (i.e., a lifting member) 17 that is vertically pivotable about a horizontal axis 28 relative to a ground surface 18 on which machine 10 is located by a pair of adjacent, double-acting, hydraulic cylinders 20 (only one shown in FIG. 1). Linkage system 12 may also include a single, double-acting, hydraulic cylinder 26 connected to tilt implement 14 relative to boom 17 in a vertical direction about a horizontal axis 30. Boom 17 may be pivotably connected at one end to a body 32 of machine 10, while implement 14 may be pivotably connected to an opposing end of boom 17. It should be noted that alternative linkage configurations may also be possible.

Numerous different implements 14 may be attachable to a single machine 10 and controlled to perform a particular task. For example, implement 14 could embody a bucket (shown in FIG. 1), a fork arrangement, a blade, a shovel, a ripper, a dump bed, a broom, a snow blower, a propelling device, a cutting device, a grasping device, or another task-performing device known in the art. Although connected in the embodiment of FIG. 1 to lift and tilt relative to machine 10, implement 14 may alternatively or additionally pivot, rotate, slide, swing, or move in any other appropriate manner.

Power source 16 may embody an engine such as, for example, a diesel engine, a gasoline engine, a gaseous fuel-powered engine, or another type of combustion engine known in the art that is supported by body 32 of machine 10 and operable to power the movements of machine 10 and implement 14. It is contemplated that the power source 16 may alternatively embody a non-combustion source of power, if desired, such as a fuel cell, a power storage device (e.g., a battery), or another source known in the art. Power source 16 may produce a mechanical or electrical power output that may then be converted to hydraulic power for moving hydraulic cylinders 20 and 26.

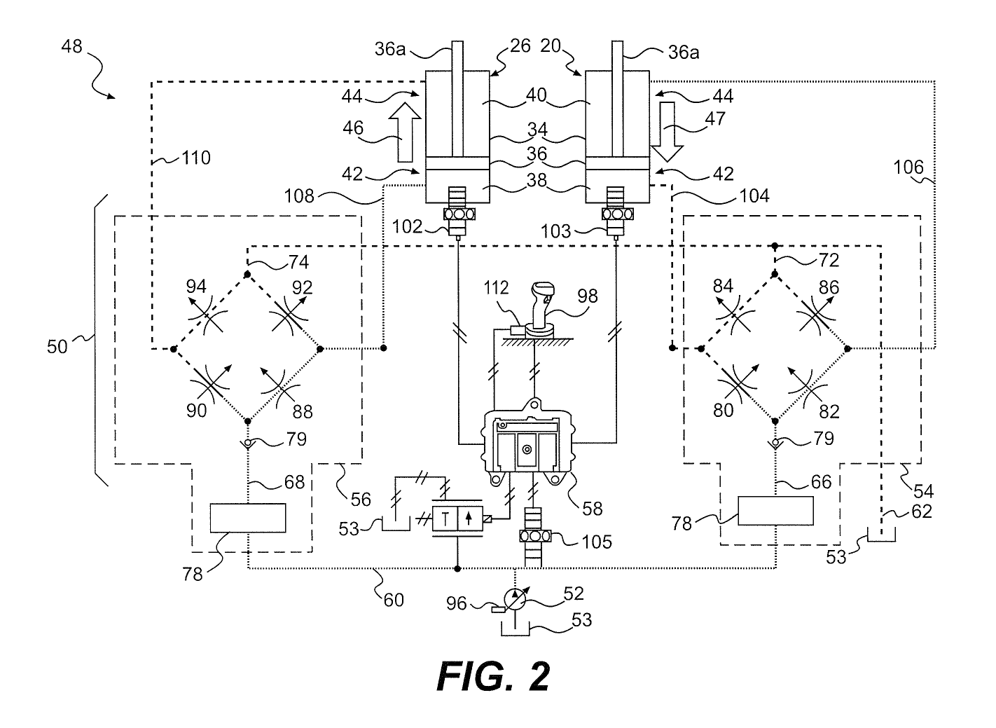

For purposes of simplicity, FIG. 2 illustrates the composition and connections of only hydraulic cylinder 26 and one of hydraulic cylinders 20. It should be noted, however, that machine 10 may include other hydraulic actuators of similar composition connected to move the same or other structural members of linkage system 12 in a similar manner, if desired.

As shown in FIG. 2, each of hydraulic cylinders 20 and 26 may include a tube 34 and a piston assembly 36 arranged within tube 34 to form a first chamber 38 and a second chamber 40. In one example, a rod portion 36a of piston assembly 36 may extend through an end of second chamber 40. As such, second chamber 40 may be associated with a rod-end 44 of its respective cylinder, while first chamber 38 may be associated with an opposing head-end 42 of its respective cylinder.

First and second chambers 38, 40 may each be selectively supplied with pressurized fluid and drained of the pressurized fluid to cause piston assembly 36 to displace within tube 34, thereby changing an effective length of hydraulic cylinders 20, 26 and moving implement 14 (FIG. 1). A flow rate of fluid into and out of first and second chambers 38, 40 may relate to a velocity of hydraulic cylinders 20, 26 and work took 14, while a pressure differential between first and second chambers 38, 40 may relate to a force imparted by hydraulic cylinders 20, 26 on implement 14. An expansion (represented by an arrow 46) and a retraction (represented by an arrow 47) of hydraulic cylinders 20, 26 may function to assist in moving implement 14 in different manners (e.g., lifting and tilting implement 14, respectively).

To help regulate filling and draining of first and second chambers 38, 40, machine 10 may include a hydraulic control system 48 having a plurality of interconnecting and cooperating fluid components. Hydraulic control system 48 may include, among other things, a valve stack 50 at least partially forming a fluid circuit between hydraulic cylinders 20, 26, an engine-driven hydraulic pump 52, and a tank 53. Valve stack 50 may include a lift valve arrangement 54, a tilt valve arrangement 56, and, in some embodiments, one or more auxiliary valve arrangements (not shown) that are fluidly connected to receive and discharge pressurized fluid in parallel fashion. In one example, valve arrangements 54, 56 may include separate bodies bolted to each other to form valve stack 50. In another embodiment, each of valve arrangements 54, 56 may be stand-alone arrangements, connected to each other only by way of external fluid conduits (not shown). It is contemplated that a greater number, a lesser number, or a different configuration of valve arrangements may be included within valve stack 50, if desired. For example, a swing valve arrangement (not shown) configured to control a swinging motion of linkage system 12, one or more travel valve arrangements, and other suitable valve arrangements may be included within valve stack 50. Hydraulic control system 48 may further include a controller 58 in communication with power source 16 and with valve arrangements 54, 56 to control power source fueling and movement of hydraulic cylinders 20, 26.

Each of lift and tilt valve arrangements 54, 56 may regulate the motion of their associated fluid actuators. Specifically, lift valve arrangement 54 may have elements movable to simultaneously control the motions of both of hydraulic cylinders 20 and thereby lift boom 17 relative to ground surface 18. Likewise, tilt valve arrangement 56 may have elements movable to control the motion of hydraulic cylinder 26 and thereby tilt implement 14 relative to boom 17.

Valve arrangements 54, 56 may be connected to regulate separate flows of pressurized fluid to and from hydraulic cylinders 20, 26 via common passages. Specifically, valve arrangements 54, 56 may be connected to pump 52 by way of a common supply passage 60, and to tank 53 by way of a common drain passage 62. Lift and tilt valve arrangements 54, 56 may be connected in parallel to common supply passage 60 by way of individual fluid passages 66 and 68, respectively, and in parallel to common drain passage 62 by way of individual fluid passages 72 and 74, respectively. A pressure compensating valve 78 and/or a check valve 79 may be disposed within each of fluid passages 66, 68 to provide a unidirectional supply of fluid having a substantially constant flow to valve arrangements 54, 56. Pressure compensating valves 78 may be pre- (shown in FIG. 2) or post-compensating (not shown) valves movable, in response to a differential pressure, between a flow passing position and a flow blocking position such that a substantially constant flow of fluid is provided to valve arrangements 54 and 56, even when a pressure of the fluid directed to pressure compensating valves 78 varies. It is contemplated that, in some applications, pressure compensating valves 78 and/or check valves 79 may be omitted, if desired.

Each of lift and tilt valve arrangements 54, 56 may be substantially identical and include four independent metering valves (IMVs). Of the four IMVs, two may be generally associated with fluid supply functions, while two may be generally associated with drain functions. For example, lift valve arrangement 54 may include a head-end supply valve 80, a rod-end supply valve 82, a head-end drain valve 84, and a rod-end drain valve 86. Similarly, tilt valve arrangement 56 may include a head-end supply valve 88, a rod-end supply valve 90, a head-end drain valve 92, and a rod-end drain valve 94.

Head-end supply valve 80 may be disposed between fluid passage 66 and a fluid passage 104 that leads to first chamber 38 of hydraulic cylinder 20, and be configured to regulate a flow rate of pressurized fluid into first chamber 38 in response to a flow command from controller 58. Head-end supply valve 80 may include a variable-position, spring-biased valve element, for example a poppet or spool element, that is solenoid actuated and configured to move to any position between a first end-position at which fluid is allowed to flow into first chamber 38, and a second end-position at which fluid flow is blocked from first chamber 38. It is contemplated that head-end supply valve 80 may also be configured to allow fluid from first chamber 38 to flow through head-end supply valve 80 during a regeneration event when a pressure within first chamber 38 exceeds a pressure of pump 52 and/or a pressure of the chamber receiving the regenerated fluid. It is further contemplated that head-end supply valve 80 may include additional or different elements than described above such as, for example, a fixed-position valve element or any other valve element known in the art. It is also contemplated that head-end supply valve 80 may alternatively be hydraulically actuated, mechanically actuated, pneumatically actuated, or actuated in another suitable manner.

Rod-end supply valve 82 may be disposed between fluid passage 66 and a fluid passage 106 leading to second chamber 40 of hydraulic cylinder 20, and be configured to regulate a flow rate of pressurized fluid into second chamber 40 in response to a flow command from controller 58. Rod-end supply valve 82 may include a variable-position, spring-biased valve element, for example a poppet or spool element, that is solenoid actuated and configured to move to any position between a first end-position at which fluid is allowed to flow into second chamber 40, and a second end-position at which fluid is blocked from second chamber 40. It is contemplated that rod-end supply valve 82 may also be configured to allow fluid from second chamber 40 to flow through rod-end supply valve 82 during a regeneration event when a pressure within second chamber 40 exceeds a pressure of pump 52 and/or a pressure of the chamber receiving the regenerated fluid. It is further contemplated that rod-end supply valve 82 may include additional or different valve elements such as, for example, a fixed-position valve element or any other valve element known in the art. It is also contemplated that rod-end supply valve 82 may alternatively be hydraulically actuated, mechanically actuated, pneumatically actuated, or actuated in another suitable manner.

Head-end drain valve 84 may be disposed between fluid passage 104 and fluid passage 72, and be configured to regulate a flow rate of pressurized fluid from first chamber 38 of hydraulic cylinder 20 to tank 53 in response to a flow command from controller 58. Head-end drain valve 84 may include a variable-position, spring-biased valve element, for example a poppet or spool element, that is solenoid actuated and configured to move to any position between a first end-position at which fluid is allowed to flow from first chamber 38, and a second end-position at which fluid is blocked from flowing from first chamber 38. It is contemplated that head-end drain valve 84 may include additional or different valve elements such as, for example, a fixed-position valve element or any other valve element known in the art. It is also contemplated that head-end drain valve 84 may alternatively be hydraulically actuated, mechanically actuated, pneumatically actuated, or actuated in another suitable manner.

Rod-end drain valve 86 may be disposed between fluid passage 106 and fluid passage 72, and be configured to regulate a flow rate of pressurized fluid from second chamber 40 of hydraulic cylinder 20 to tank 53 in response to a flow command from controller 58. Rod-end drain valve 86 may include a variable-position, spring-biased valve element, for example a poppet or spool element, that is solenoid actuated and configured to move to any position between a first end-position at which fluid is allowed to flow from second chamber 40, and a second end-position at which fluid is blocked from flowing from second chamber 40. It is contemplated that rod-end drain valve 86 may include additional or different valve elements such as, for example, a fixed-position valve element or any other valve element known in the art. It is also contemplated that rod-end drain valve 86 may alternatively be hydraulically actuated, mechanically actuated, pneumatically actuated, or actuated in another suitable manner.

Head-end supply valve 88 may be disposed between fluid passage 68 and a fluid passage 108 that leads to first chamber 38 of hydraulic cylinder 26, and be configured to regulate a flow rate of pressurized fluid into first chamber 38 in response to a flow command from controller 58. Head-end supply valve 88 may include a variable-position, spring-biased valve element, for example a poppet or spool element, that is solenoid actuated and configured to move to any position between a first end-position at which fluid is allowed to flow into first chamber 38, and a second end-position at which fluid flow is blocked from first chamber 38. It is contemplated that head-end supply valve 88 may be also configured to allow fluid from first chamber 38 to flow through head-end supply valve 88 during a regeneration event when a pressure within first chamber 38 exceeds a pressure of pump 52 and/or a pressure of the chamber receiving the regenerated fluid. It is further contemplated that head-end supply valve 88 may include additional or different elements such as, for example, a fixed-position valve element or any other valve element known in the art. It is also contemplated that head-end supply valve 88 may alternatively be hydraulically actuated, mechanically actuated, pneumatically actuated, or actuated in another suitable manner.

Rod-end supply valve 90 may be disposed between fluid passage 68 and a fluid passage 110 that leads to second chamber 40 of hydraulic cylinder 26, and be configured to regulate a flow rate of pressurized fluid into second chamber 40 in response to a flow command from controller 58. Specifically, rod-end supply valve 90 may include a variable-position, spring-biased valve element, for example a poppet or spool element, that is solenoid actuated and configured to move to any position between a first end-position, at which fluid is allowed to flow into second chamber 40, and a second end-position, at which fluid is blocked from second chamber 40. It is contemplated that rod-end supply valve 90 may also be configured to allow fluid from second chamber 40 to flow through rod-end supply valve 90 during a regeneration event when a pressure within second chamber 40 exceeds a pressure of pump 52 and/or a pressure of the chamber receiving the regenerated fluid. It is further contemplated that rod-end supply valve 90 may include additional or different valve elements such as, for example, a fixed-position valve element or any other valve element known in the art. It is also contemplated that rod-end supply valve 90 may alternatively be hydraulically actuated, mechanically actuated, pneumatically actuated, or actuated in another suitable manner.

Head-end drain valve 92 may be disposed between fluid passage 108 and fluid passage 74, and be configured to regulate a flow rate of pressurized fluid from first chamber 38 of hydraulic cylinder 26 to tank 53 in response to a flow command from controller 58. Specifically, head-end drain valve 92 may include a variable-position, spring-biased valve element, for example a poppet or spool element, that is solenoid actuated and configured to move to any position between a first end-position at which fluid is allowed to flow from first chamber 38, and a second end-position at which fluid is blocked from flowing from first chamber 38. It is contemplated that head-end drain valve 92 may include additional or different valve elements such as, for example, a fixed-position valve element or any other valve element known in the art. It is also contemplated that head-end drain valve 92 may alternatively be hydraulically actuated, mechanically actuated, pneumatically actuated, or actuated in another suitable manner.

Rod-end drain valve 94 may be disposed between fluid passage 110 and fluid passage 74, and be configured to regulate a flow rate of pressurized fluid from second chamber 40 of hydraulic cylinder 26 to tank 53 in response to a flow command from controller 58. Rod-end drain valve 94 may include a variable-position, spring-biased valve element, for example a poppet or spool element, that is solenoid actuated and configured to move to any position between a first end-position at which fluid is allowed to flow from second chamber 40, and a second end-position at which fluid is blocked from flowing from second chamber 40. It is contemplated that rod-end drain valve 94 may include additional or different valve element such as, for example, a fixed-position valve element or any other valve elements known in the art. It is also contemplated that rod-end drain valve 94 may alternatively be hydraulically actuated, mechanically actuated, pneumatically actuated, or actuated in another suitable manner.

Pump 52 may have variable displacement and be load-sense controlled to draw fluid from tank 53 and discharge the fluid at a specified elevated pressure to valve arrangements 54, 56. That is, pump 52 may include a stroke-adjusting mechanism 96, for example a swashplate or spill valve, a position of which is hydro-mechanically adjusted based on a sensed load of hydraulic control system 48 to thereby vary an output (e.g., a discharge rate) of pump 52. The displacement of pump 52 may be adjusted from a zero displacement position at which substantially no fluid is discharged from pump 52, to a maximum displacement position at which fluid is discharged from pump 52 at a maximum rate. In one embodiment, a load-sense passage (not shown) may direct a pressure signal to stroke-adjusting mechanism 96 and, based on a value of that signal (i.e., based on a pressure of signal fluid within the passage), the position of stroke-adjusting mechanism 96 may change to either increase or decrease the output of pump 52 and thereby maintain the specified pressure. Pump 52 may be drivably connected to power source 16 of machine 10 by, for example, a countershaft, a belt, or in another suitable manner. Alternatively, pump 52 may be indirectly connected to power source 16 via a torque converter, a gear box, an electrical circuit, or in any other manner known in the art. As a result of the connection between pump 52 and power source 16, changes in loading on pump 52 may be mechanically, electrically, and/or otherwise transmitted to power source during operation of machine 10.

Tank 53 may constitute a reservoir configured to hold a supply of fluid. The fluid may include, for example, a dedicated hydraulic oil, an engine lubrication oil, a transmission lubrication oil, or any other fluid known in the art. One or more hydraulic circuits within machine 10 may draw fluid from and return fluid to tank 53. It is also contemplated that hydraulic control system 48 may be connected to multiple separate fluid tanks, if desired.

Controller 58 may embody a single microprocessor or multiple microprocessors that include components for controlling valve arrangements 54, 56 based on, among other things, input from an operator of machine 10 and/or one or more sensed operational parameters. Numerous commercially available microprocessors can be configured to perform the functions of controller 58. It should be appreciated that controller 58 could readily be embodied in a general machine microprocessor capable of controlling numerous machine functions. Controller 58 may include a memory, a secondary storage device, a processor, and any other components for running an application. Various other circuits may be associated with controller 58 such as power supply circuitry, signal conditioning circuitry, solenoid driver circuitry, and other types of circuitry.

Controller 58 may receive operator input and/or requests associated with a desired movement of implement 14 by way of one or more operator interface devices 98 that are located within an operator station of machine 10. Operator interface devices 98 may embody, for example, single or multi-axis joysticks, levers, or other known interface devices located proximate an onboard operator seat (if machine 10 is directly controlled by an onboard operator) or located within a remote station offboard machine 10. Each operator interface device 98 may be a proportional-type device that is movable through a range from a neutral position to a maximum displaced position. Such movement may generate a corresponding position and/or displacement signal that is indicative of a desired implement movement. In addition, a rate of movement (i.e., a position change rate) of operator interface device 98 may be indicative of a desired velocity of implement 14 caused by hydraulic cylinders 20, 26, for example desired lift and tilt velocities of implement 14. The desired lift and tilt velocity signals may be generated independently or simultaneously by the same or different operator interface devices 98, and be directed to controller 58 for further processing.

In some embodiments, a mode button (not shown) or other similar activating component may be associated with operator interface devices 98 and utilized by the operator of machine 10 to initiate machine operation in a particular mode. For example, a mode button may be located on the same operator interface device 98 utilized to request particular lift and/or tilt velocities, and be selectively activated by the operator to implement a mode of operation that fixes a relationship between implement lifting and tilting so as to alleviate tilt adjusting required by the operator during lifting. This fixed relationship mode of operation may be commonly known as parallel lift, and function to maintain a particular angle of implement 14 relative to ground surface 18 during lifting without the operator being required to simultaneously correct the naturally occurring implement tilt. The same or another button associated with interface devices 98 may be utilized by the operator to set the particular angle maintained during parallel lift. For example, the operator may move implement 14 to a desired orientation, and then activate mode button to indicate the current orientation is the desired orientation.

One or more maps relating the interface device signals, the corresponding desired implement velocities, associated flow rates, pressures, and/or flow requests, valve element positions, pump pressures, speeds, and/or flow rates, modes of operation, operator interface device positions, operator interface device position change rates, and/or other parameters may be stored in the memory of controller 58. Collectively, such parameters may be referred to herein as “operating characteristics” of machine 10, and one or more such operating characteristics of machine 10 may measured, sensed, calculated, and/or otherwise determined by one or more sensors of machine 10 in an open-loop or closed-loop manner. Such operating characteristics are not limited to those listed above, and such sensors will be described in greater detail below. Each of the maps described herein may be in the form of tables, graphs, and/or equations. Controller 58 may be configured to allow the operator to directly modify these maps and/or to select specific maps from available relationship maps stored in the memory of controller 58 to affect actuation of hydraulic cylinders 20, 26. It is also contemplated that the maps may be automatically selected for use by controller 58 based on sensed or determined modes of machine operation, if desired.

Controller 58 may be configured to receive inputs and/or operator requests from interface device 98, and to command operation of valve arrangements 54, 56 in response to the inputs and/or requests based on the relationship maps described above. Controller 58 may also be configured to generate a power source fueling signal and/or otherwise command power source fueling based on the relationship maps described above. Specifically, controller 58 may receive the interface device signals indicative of desired implement movement, and reference the selected and/or modified relationship maps stored in the memory of controller 58 to determine desired flow rates for the appropriate supply and/or drain elements within valve arrangements 54, 56. The desired flow rates can then be commanded of the appropriate supply and drain elements to cause filling of particular chambers within hydraulic cylinders 20, 26 at rates that correspond with the desired implement velocities in the selected operational mode.

Controller 58 may also receive signals and/or information from one or more sensors during operation of machine 10. The information may include, for example, sensory information regarding the lift velocity and movement of implement 14 relative to ground surface 18. The information may also include sensory information regarding a position of operator interface 98, a position change rate associated with the operator interface device 98, pump pressure, pump speed, and/or other operating characteristics indicative of a load placed on implement 14. Such operating characteristics may include, for example, hydraulic pressures associated with one or more of the hydraulic cylinders 20, 26, valve arrangements 54, 56, fluid passages 66, 68, and/or other components of the hydraulic control system 48.

For example, in the embodiment shown in FIG. 2, lift velocity information may be provided by way of a velocity sensor 103 associated with hydraulic cylinders 20, while orientation information may be provided by way of a position sensor 102 associated with hydraulic cylinder 26. Sensors 102, 103 may each embody a magnetic pickup-type sensor associated with a magnet (not shown) embedded within the piston assembly 36 of the different hydraulic cylinders 20, 26. In this configuration, sensors 102, 103 may each be configured to detect an extension position of the corresponding hydraulic cylinder 20, 26 by monitoring the relative location of the magnet, and generate corresponding position signals directed to controller 58 for further processing. It is contemplated that sensors 102, 103 may alternatively embody other types of sensors such as, for example, magnetostrictive-type sensors associated with a wave guide (not shown) internal to hydraulic cylinders 20, 26, cable type sensors associated with cables (not shown) externally mounted to hydraulic cylinders 20, 26, internally- or externally-mounted optical sensors, rotary style sensors associated with joints pivotable by hydraulic cylinders 20, 26, or any other type of sensors known in the art. From the position signals generated by sensors 102, 103 and based on known geometry and/or kinematics of hydraulic cylinders 20, 26 and linkage system 12, controller 58 may be configured to calculate the lift velocity and orientation of implement 14 relative to body 32 and/or ground surface 18.

In the embodiment shown in FIG. 2, the pressure of hydraulic control system 48 may be directly or indirectly measured by way of a pressure sensor 105. Pressure sensor 105 may embody any type of sensor configured to generate a signal indicative of a pressure of hydraulic control system 48. For example, pressure sensor 105 may be a strain gauge-type, capacitance-type, or piezo-type compression sensor configured to generate a signal proportional to a compression of an associated sensor element by fluid in communication with the sensor element. Signals generated by pressure sensor 105 may be directed to controller 58 for further processing.

In addition, position and/or position change rates associated with the operator interface device 98 may be directly or indirectly measured by way of a sensor 112. Sensor 112 may embody a magnetic pickup-type sensor associated with a magnet (not shown) embedded within the operator interface device 98. In this configuration, sensor 112 may be configured to measure and/or otherwise determine a position of the operator interface device 98 by monitoring the relative location of the magnet, and generate corresponding position signals directed to controller 58 for further processing. It is contemplated that sensor 112 may alternatively embody any other type of proximity and/or movement sensor such as, for example, a gyroscope associated with the operator interface device 98, a cable-type sensor associated with cables (not shown) externally mounted to operator interface device 98, internally- or externally-mounted optical sensors, rotary style sensors, and/or any other type of sensor known in the art. From the position signals and/or position change rate signals generated by sensor 112, controller 58 may be configured to calculate the velocity, acceleration, deceleration, and/or position of the operator interface device. Such signals and/or calculated values may be indicative of a desired movement of implement 14, and such a desired movement may require a corresponding change in loading on hydraulic pump 52.

Controller 58 may be configured to regulate operations of linkage system 12 in response to operator inputs and/or requests. For example, as implement 14 is loaded with material, hydraulic pump 52 may responsively command an increased torque output from power source 16. Based on the command for increased torque output, controller 58 may generate a power source fueling signal corresponding to the required increase in torque. In particular, the fueling signal may be provided to one or more fuel injectors (not shown) or other fueling components of power source 16. The fueling signal may increase an amount of fuel directed to power source 16 so as to increase torque output by power source 16 in an amount sufficient to satisfy the increased torque requirement of hydraulic pump 52. As a result, power source 16 may output torque sufficient to satisfy the change in loading on the hydraulic pump 52. A decrease in loading on hydraulic pump 52 may similarly result in a command for less torque output (or even reverse torque output) by power source 16.

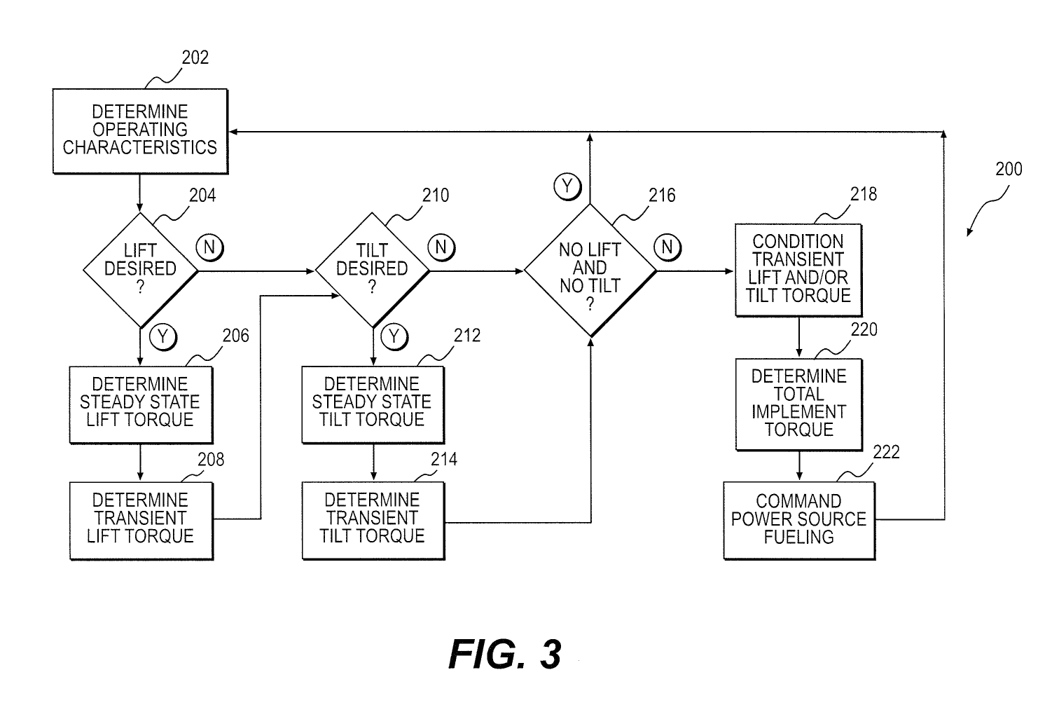

Controller 58 may be further configured to anticipate changes in loading, and affect operation of power source 16 before performance of power source 16 deviates from desired ranges (i.e., before the change in loading on hydraulic pump 52 is transferred to power source 16 causing power source 16 to lug or overspeed significantly). The flowchart 200 depicted in FIG. 3 illustrates an exemplary method of anticipatory control performed by controller 58. This method will be discussed in more detail in the following section to further illustrate the disclosed concepts.

### INDUSTRIAL APPLICABILITY

The disclosed systems and methods may be implemented into any mobile machine application where performance fluctuations are undesirable. The systems and methods described herein may help reduce performance fluctuations by accounting for impending load changes before the load changes are transmitted to the power source. An exemplary method of controlling power source 16 will now be described with respect to FIG. 3.

During operation of machine 10, a machine operator may manipulate operator interface device 98 to request lifting and/or tilting movements of implement 14. For example, the operator may move interface device 98 in the fore/aft direction to request lifting of implement 14 downward (i.e., lowering) toward ground surface 18 with the force of gravity and upward (i.e., raising) away from ground surface 18 against the force of gravity, respectively. The operator may also move operator interface device 98 in the left/right direction to request a rearward tilting (i.e., racking) of implement 14 and a forward tilting (i.e., dumping) of implement 14, respectively. While the displacement positions of interface device 98 in the fore/aft and left/right directions may be related to operator desired lift and tilt movements of implement 14, the speed with which operator manipulates operator interface device 98 (i.e., the position change rate of the operator interface device 89) may be indicative of the operator desired lift and tilt velocities of implement 14 during movement. Requests from the operator indicative of a desired movement of implement 14 may be generated by the operator interface device 89 and/or any of the sensors 102, 103, 105, 112 described herein, and such requests may be directed to and/or received by controller 58.

For example, the position of the operator interface device 98 and the position change rate associated with the operator interface device 98 may be determined at Step: 202 along with one or more additional operating characteristics of machine 10. Such operating characteristics may be determined by one or more of the sensors 102, 103, 105, 112 described herein in an open-loop or closed-loop manner. For example, one or more of the sensors 102, 103, 105, 112 may generate velocity signals indicative of the operator desired lift and/or tilt velocities of implement 14 during movement, and may direct these velocity signals to controller 58 for further processing. In general, such velocity signals may be positive when associated with upward lifting and racking, and negative when associated with lowering and dumping. It is understood that operating characteristics determined at Step: 202 may also include one or more of, for example, a speed of pump 52, a pressure of pump 52 and/or other components of hydraulic control system 48, and a flow request associated with implement 14. For example, sensors 102, 103 associated with hydraulic cylinders 26, 20, respectively, may send a signal indicative of a requested flow of hydraulic fluid to controller 58. Alternatively, sensor 112 may determine a position and/or a position change rate associated with operator interface device 98. Sensor 112 may send a signal indicative of the position and/or position change rate to controller 58, and controller 58 may input such information into one or more maps, look-up tables, graphs, and/or equations stored in a memory thereof. In such an exemplary embodiment, the implement flow request may be an output of such maps, look-up tables, graphs, and/or equations.

At Step: 204, controller 58 may determine whether lifting of implement 14 is desired. Such a determination may be made based on one or more of the operating characteristics determined at Step: 202. For example, as described above, the operator may move interface device 98 in the fore/aft direction to request lifting of implement 14 downward (i.e., lowering) toward ground surface 18 with the force of gravity or upward (i.e., raising) away from ground surface 18 against the force of gravity, respectively. The displacement and/or positions of interface device 98 in the fore/aft directions may be determined by sensor 112, and sensor 112 may provide one or more signals to controller 58 indicative of such displacement and/or positions. If controller 58 determines lifting (either raising or lowering) of implement 14 is desired based on such signals (Step: 204—Yes), control may proceed to Step: 206 where controller 58 may determine a steady state lift torque that will be required from power source 16 to satisfy the operator's implement movement request.

At Step: 206, controller 58 may determine the steady state lift torque based on, for example, the pump pressure, pump speed, implement flow request, and/or other operating characteristics determined at Step: 202. In determining steady state lift torque at Step: 206, controller 58 may input such operating characteristic into one or more equations, maps, look-up tables, graphs, and/or other means, and the steady state lift torque may be an output of such means. It is understood that the pressure and /or speed of pump 52 may be directly measured or, alternatively, calculated as a function of other operating characteristics, such as pump displacement and/or hydraulic system pressure. In exemplary embodiments, the displacement of pump 52 may be a known fixed value, a variable sensed value, an assumed value, a commanded value, or a combination of such values, as desired.

Moreover, as used herein, the term “steady state” torque may be defined as and/or may be indicative of the power source torque output required to satisfy the request of the operator as determined responsively based on one or more determined machine operating characteristics. Accordingly, the steady state lift torque determined at Step: 206 may be a real-time estimate of the torque required from power source 16 to satisfy the change in loading on hydraulic pump 52 corresponding to the desired movement (i.e., lifting) of implement 14.

Controlling power source fueling based on such steady state torques may be sufficient in relatively low frequency response situations in which the change in loading on hydraulic pump 52 is relatively slow. However, in many operating conditions, the change in loading on hydraulic pump 52 results from a relatively high frequency operator request. Such requests may be characterized by relatively rapid movement of operator interface device 98, and such movement may be indicative of the operator's desire for a correspondingly rapid movement of implement 14. In such operating conditions, mechanical and/or electronic delay associated with the combustion process and/or providing fuel to the power source 16 may hinder the ability of the power source 16 to, for example, increase torque output quickly enough to avoid lugging or to decrease torque output quickly enough to avoid overspeed. As a result, controlling power source fueling based solely on such steady state torques may result in inefficient operation of power 16.

Thus, to improve operational efficiency, controller 58 may determine a transient lift torque at Step: 208. Such a transient torque may be determined based on, for example, at least one of the implement flow request, the position change rate associated with operator interface device 98, the position of operator interface device 98, and/or other operating characteristics determined at Step: 202. In exemplary embodiments, the position change rate associated with operator interface device 98 may be directly measured or, alternatively, calculated as a function of other operating characteristics, such as the position of operator interface device 98. In exemplary embodiments, the position change rate may be calculated by controller 58 as the first derivative of the position of operator interface device 98.

As used herein, the term “transient” torque may be defined as and/or may be indicative of the power source torque output required, in addition to or subtracted from a corresponding steady state torque, to satisfy an anticipated high-frequency component of the request received from the operator. Accordingly, the transient lift torque determined at Step: 208 may be an anticipatory estimate of the additional torque required from power source 16 to satisfy a relatively rapid change in loading on hydraulic pump 52. In exemplary embodiments, the transient lift torque determined at Step: 208 may be required from the time the change in loading is first determined to the time the steady state lift torque determined at Step: 206 is actually output by power source 16. Once the steady state lift torque determined at Step: 206 is actually output by power source 16, the transient lift torque determined at Step: 208 may be substantially equal to zero. Controlling power source fueling based on the steady state torque determined at Step: 206 in combination with the transient torque determined at Step: 208 may assist in, for example, increasing power source torque output quickly enough to avoid lugging and decreasing torque output quickly enough to avoid overspeed. In particular, controlling power source fueling based on such transient torques may assist in increasing or decreasing power source torque output, as necessary, prior to transmission of the change in loading on hydraulic pump 52 to power source 16. By, for example, providing fuel to power source 16 based on such transient torques, lugging and/or overspeed may be avoided, and operational efficiency of power source 16 may be improved.

In exemplary embodiments, the transient torques described herein may be determined based on one or more additional operating characteristics of machine 10 including, but not limited to, a mechanical delay associated with providing fuel to power source 16, an electronic delay associated with providing fuel to power source 16, and a gain associated with the determined transient torque. The mechanical delay may be a time lag or delay associated with one or more mechanical, hydraulic, and/or pneumatic components of machine 10. For example, the mechanical delay may be a length of time elapsing between providing fuel to power source 16 based on a fueling command and/or signal, and power source 16 actually providing torque sufficient to satisfy a change in loading on hydraulic pump 52. Since power generation by power source 16 is not instantaneous, such a mechanical delay may be a characteristic of the internal combustion process and/or other like processes performed by power source 16 in generating power. For example, such a mechanical delay may be associated with increasing or decreasing output torque in order to satisfy the steady state torque calculated at Step: 206. Such a mechanical delay may be measured, calculated, estimated, assumed, and/or otherwise determined based on any of the operating characteristics described herein including, but not limited to power source speed, machine travel speed, the age of power source 16, and the condition of power source 16. In exemplary embodiments, such a mechanical delay may be between approximately 20 milliseconds and approximately 80 milliseconds.

The electronic delay may be a time lag or delay associated with one or more electrical components of machine 10. For example, the electronic delay may be a length of time elapsing between controller 58 generating a fueling command and/or signal and actually providing fuel to power source 16 based on the fueling signal. Since generation of such a fueling signal and transmission of the signal to one or more fueling components of power source 16 is not instantaneous, such an electronic delay may be a characteristic of controller 58 and/or the electrical connections between controller 58 and fueling components of power source 16. For example, such an electronic delay may be associated with a processor speed of controller 58, a memory type, speed, and/or capacity of controller 58, and/or a type of connection between controller 58 and fueling components of power source 16. It is understood that such fueling components may comprise one or more pumps, valves, actuators, injectors, and/or other like components configured to assist in providing fuel to power source 16. Such an electronic delay may be measured, calculated, estimated, assumed, and/or otherwise determined based on any of the operating characteristics described herein. In exemplary embodiments, such an electronic delay may be between approximately 1 millisecond and approximately 20 milliseconds.

The gain associated with the transient torque may be a value and/or other metric indicative of the effect of transient torque on a total torque determined by controller 58. For example, the gain may be a coefficient used in one or more equations employed to calculate transient torque and/or total torque, and the gain value utilized may govern, for example, the percentage of the transient torque used in determining the total torque. For example, when one or more of the mechanical delay, electronic delay, and/or position change rate are relatively large in magnitude, the gain value utilized may be close to one. In such embodiments, controller 58 may use substantially the entire value of the transient torque to control fueling of power source 16, and the effect of the determined transient torque may be maximized. In contrast, when one or more of the mechanical delay, electronic delay, and/or position change rage are relatively small in magnitude, the gain value utilized may be close to zero. In such embodiments, controller 58 may use only a small fraction of the value of the transient torque to control fueling of power source 16, and the effect of the determined transient torque may be minimized. The gain may be measured, calculated, estimated, assumed, and/or otherwise determined based on any of the operating characteristics described herein. In exemplary embodiments, gain values may be determined through laboratory testing and may be periodically updated as machine 10 ages or as worksite conditions change. Such gain values may be stored in a memory, chart, graph, look-up table, and/or other components of controller 58.

Upon determining a transient lift torque at Step: 208, or in response to determining that lift is not required (Step: 204—No), control may proceed to Step 210 where controller 58 may determine whether tilting of implement 14 is desired. Such a determination may be made based on one or more of the operating characteristics determined at Step: 202. For example, as described above, the operator may move operator interface device 98 in the left/right direction to request a rearward tilting (i.e., racking) of implement 14 and a forward tilting (i.e., dumping) of implement 14, respectively. The displacement and/or positions of interface device 98 in the left/right directions may be determined by sensor 112, and sensor 112 may provide one or more signals to controller 58 indicative of such displacement and/or positions. If controller 58 determines tilting (either racking or dumping) of implement 14 is desired based on such signals (Step: 210—Yes), control may proceed to Step: 212 where controller 58 may determine a steady state tilt torque that will be required to satisfy the operator's request.

At Step: 212, controller 58 may determine the steady state tilt torque based on, for example, the pump pressure, pump speed, implement flow request, and/or other operating characteristics determined at Step: 202. In exemplary embodiments, substantially similar and/or analogous inputs used to determine the steady state lift torque at Step: 206 may be employed by controller 58 to determine the steady state tilt torque at Step: 212. It is also understood that in determining the steady state tilt torque at Step: 212, controller 58 may employ substantially similar and/or analogous equations, maps, look-up tables, graphs, and/or other means as those used at Step: 206. In such embodiments, the steady state tilt torque determined at Step: 212 may be a real-time estimate of the torque required from power source 16 to satisfy the change in loading on hydraulic pump 52 corresponding to the desired movement (i.e., tilting) of implement 14.

At Step: 214, controller 58 may determine a transient tilt torque. Such a transient torque may be determined based on, for example, at least one of the implement flow request, the position change rate associated with operator interface device 98, the position of operator interface device 98, and/or other operating characteristics determined at Step: 202. In exemplary embodiments, substantially similar and/or analogous inputs used to determine the transient lift torque at Step: 208 may be employed by controller 58 to determine the transient tilt torque at Step: 214. It is also understood that in determining the transient tilt torque at Step: 214, controller 58 may employ substantially similar and/or analogous equations, maps, look-up tables, graphs, and/or other means as those used at Step: 208. The transient tilt torque determined at Step: 214 may be an anticipatory estimate of the additional tilt torque required from power source 16 to satisfy the relatively rapid change in loading on hydraulic pump 52. In exemplary embodiments, the transient tilt torque determined at Step: 214 may be required from the time the change in loading is first determined to the time the steady state tilt torque determined at Step: 212 is actually output by power source 16. Once the steady state tilt torque determined at Step: 212 is actually output by power source 16, the transient tilt torque determined at Step: 214 may be substantially equal to zero. As described above with respect to Step: 208, in exemplary embodiments the transient tilt torque may be determined at Step: 214 based on one or more additional operating characteristics of machine 10 including, but not limited to, a mechanical delay associated with providing fuel to power source 16, an electronic delay associated with providing fuel to power source 16, and a gain associated with the determined transient torque.

Upon determining a transient tilt torque at Step: 214, or in response to determining that tilt is not required (Step: 210—No), control may proceed to Step 216 where controller 58 may determine if neither lifting nor tilting of implement 14 is desired. Such a determination may be made based on one or more of the operating characteristics determined at Step: 202. For example, as described above, the operator may move operator interface device 98 in the left/right or fore/aft directions to request a corresponding movement of implement 14. The displacement and/or positions of interface device 98 may be determined by sensor 112, and sensor 112 may provide one or more signals to controller 58 indicative of such displacement and/or positions. If controller 58 determined at Steps: 204 and 210 that neither lifting nor tilting was desired by the operator based on negligible movement of operator interface device 98 (Step: 216—Yes), control may proceed to Step: 202, in a closed-loop manner, where controller 58, sensors 102, 103, 105, 112, and/or other components of machine 10 may determine additional operating characteristics of machine 10.

If, on the other hand, controller 58 determines at Step: 216 that lifting was required at Step: 204 or that tilting was required at Step: 210 (Step: 216—No), control may proceed to Step: 218 where controller 58 may condition at least one of the transient lift torque determined at Step: 208 and the transient tilt torque determined at Step: 214. Conditioning the transient torques at Step: 218 may include any modification to the transient lift and/or tilt torques required to maintain efficient operation of power source 16 while hydraulic pump 52 experiences a change in loading. For example, in some situations, the change in loading on hydraulic pump 52 may be highly transient, changing 40-50 times per second. Because power source 16 may be relatively slow to respond to changes in loading (as compared to hydraulic pump 52), trying to change the mechanical output of power source 16 as frequently as the demand from hydraulic pump 52 changes could cause power source performance to fluctuate undesirably and even out of phase relative to the demand. That is, power source 16 could be caused to increase its output when the corresponding demand for increased output no longer exists or is even replaced with a demand for decreased output, and vice versa. Accordingly, at Step: 218 controller 58 may be configured to limit a change rate associated with the transient lift and/or tilt torques, before using the transient lift and/or tilt torques to determine a total torque required from power source 16 (Step: 220). Thus, at Step: 218, controller 58 may limit a rate of change associated with one or both of the transient lift torque and the transient tilt torque prior to adjusting power source fueling.

At Step: 218, controller 58 may limit the rate of change associated with one or both of the transient lift torque and the transient tilt torque in any suitable manner. In one exemplary embodiment, controller 58 may limit the rate of change based on a predetermined change rate threshold. For example, when consecutively determined transient lift and/or tilt torques change by less than a respective change rate threshold within about one second, controller 58 may use the full value of the transient lift and/or tilt torque in determining a total torque at Step: 220. However, when consecutively determined transient lift and/or tilt torques change by greater than a respective change rate threshold within about one second, controller 58 may reduce the value of the transient lift and/or tilt torque in determining a total torque at Step: 220. Such a reduction may be based on any desired percentage, such as, for example, between approximately 10 percent and approximately 20 percent. Alternatively, in further additional embodiments, Step: 218 may be omitted or may be included in the calculations made at Step: 208 and/or Step: 214.

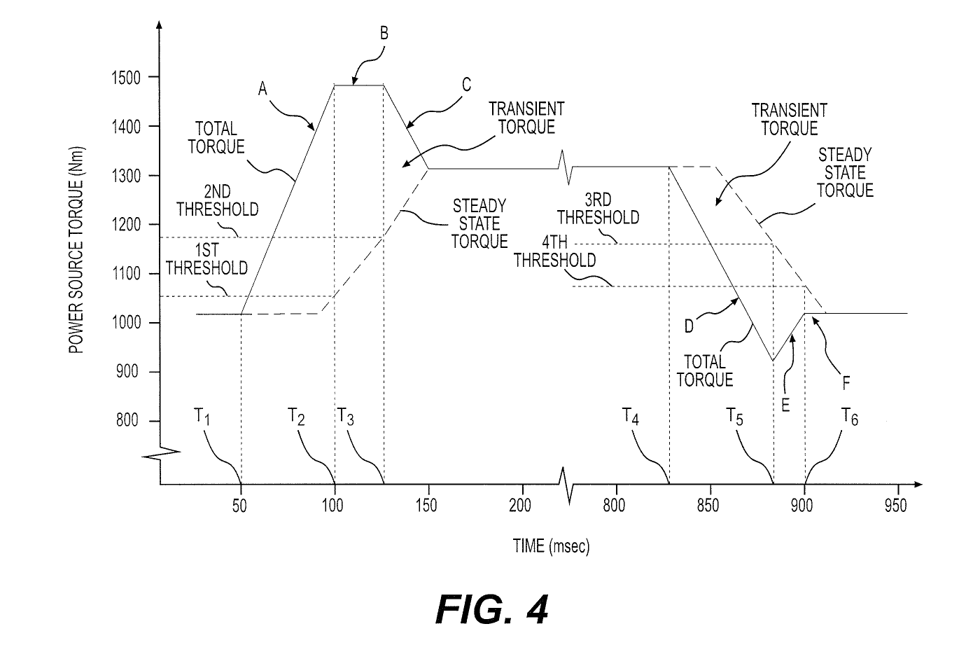

At Step: 220, controller 58 may determine a total torque required by power source 16 to satisfy the change in loading on hydraulic pump 52. For example, controller 58 may sum the individual torque values determined at Steps: 206, 208, 212, and 214 to determine an anticipated total torque load value for use in controlling power source fueling. In further embodiments, one or more of the conditioned transient lift and/or tilt torque values determined at Step: 218 may be used at Step: 220 in determining the total torque. As will be described in greater detail below, such total torque is illustrated by the exemplary torque curve shown in FIG. 4.

At Step: 222, the total torque determined at Step: 220 may be employed to command power source fueling. For example, at Step: 222 controller 58 may generate a power source fueling signal based on the steady state and/or transient torques described above with respect to Steps: 206, 208, 212, and 214, and such a fueling signal may correspond to the total torque determined at Step: 220. Controller 58 may generate the fueling signal at Step: 222 by referencing the total torque (Step: 220) with a control map, equation, look-up table, graph, and/or other means stored in a memory thereof. The control map, equation, look-up table, graph, and/or other means may be determined through laboratory testing and may be periodically updated as machine 10 ages and/or as worksite conditions change.

As described above, the fueling signal generated at Step: 222 may be provided to one or more fueling components of power source 16, and in exemplary embodiments, fuel may be provided to power source 16 based on the fueling signal prior to transmission of the change in loading on hydraulic pump 52 to power source 16. In this way, power source 16 may begin increasing or decreasing, for example, torque output prior to receiving a relatively high-frequency (i.e., transient) torque demand from hydraulic pump 52. In exemplary embodiments, in generating the fueling signal at Step: 222, controller 58 may determine an anticipated change in power source loading that will be caused by the transient change in loading on hydraulic pump 52. Such a determination may be made by entering, for example, the total torque determined at Step: 220 into one or more control maps, equations, look-up tables, graphs, and/or other means stored in a memory of controller 58, and such a corresponding anticipated change in power source loading may be an output of such means. The anticipated change in power source loading may comprise, for example, an anticipated power source output torque that will be required once the change in loading of on hydraulic pump 52 is transmitted to power source 16. In such exemplary embodiments, controller 58 may control fueling components of power source 16 to provide fuel to power source 16, prior to transmission of the change in loading on hydraulic pump 52 to power source 16, based on the determined anticipated change in power source loading. By controlling power source fueling in this way, power source lugging and/or overspeed may be prevented. Control may then proceed from Step: 222 to Step: 202 in a closed-loop manner.

FIG. 4 illustrates a torque curve according to an exemplary embodiment of the present disclosure. In such an exemplary embodiment, a load may be applied to implement 14 at approximately T₁. For example, upon loading implement 14 with material at T₁, an operator of machine 10 may quickly move operator interface device 98 in the aft direction indicating the operator's desire to rapidly lift the loaded implement 14 away from the ground surface 18. Beginning at T₁, controller 58 may control the total torque output by power source 16 to increase as shown at section A of the total torque curve. In particular, the request for rapid movement of loaded implement 14 at T₁ may result in a corresponding rapid increase in loading on hydraulic pump 52. To account for such change in loading, and to avoid lugging of power source 16, controller 58 may begin determining, at T₁, transient and steady state lift torques, in a closed-loop manner, as described above with respect to FIG. 3. It is understood that if both lift and tilt are required at T₁, controller 58 may begin determining, at T₁, transient lift torques, steady state lift torques, transient tilt torques, and steady state tilt torques. For example, for each time T illustrated in FIG. 4, the total torque output by power source 16 may be substantially equal to the sum of the steady state lift and/or tilt torque (represented by the dashed line in FIG. 4) and the transient lift and/or tilt torque (represented as the area between the total torque curve and the steady state torque curve).

As shown with respect to section A of the total torque curve in FIG. 4, controller 58 may increase power source torque based on, for example, transient lift torques determined in a closed-loop manner. Controller 58 may increase power source torque in this way (i.e., in response to an operator request indicative of implement movement) until determining that a desired rate of implement movement associated with the operator's request decreases. For example, as described above, such a request may be provided to controller 58 in response to movement of operator interface device 98. Controller 58 may determine that the desired rate of implement movement decreases based on, for example, a decrease in the velocity of operator interface device movement. Such a decrease in the desired rate of implement movement is represented at T₂.

Upon determining a decrease in the desired rate of implement movement at T₂, controller 58 may maintain power source torque output substantially constant as shown at section B of the total torque curve. In exemplary embodiments, controller 58 may maintain power source torque output substantially constant in response to determining that both the desired rate of implement movement decreases at T₂, and that the steady state torque determined at T₂ is greater than a first threshold. Controller 58 may maintain power source torque output substantially constant until the steady state torque increases to a second threshold greater than the first threshold illustrated in FIG. 4. As shown at section C of the total torque curve, controller 58 may then decrease power source torque output in response to determining that the steady state torque is greater than the second threshold. Such a decrease in power source torque output may begin at T₃, and controller 58 may decrease power source torque output until a determined transient toque is substantially equal to zero. When such a transient torque is substantially equal to zero, the total torque may be substantially equal to the steady state torque, and no additional (i.e., transient) torque may be required for power source 16 to fully satisfy the demand of hydraulic pump 52. It is understood that the exemplary torques and/or control methods discussed with respect to sections A, B, and C of the torque curve illustrate in FIG. 4 may be characteristic of a desired and/or requested implement movement in a direction away from ground surface 18 on which machine 10 is located.

On the other hand, exemplary torques and/or control methods associated with sections D, E, and F of the torque curve illustrated in FIG. 4 may be characteristic of a desired and/or requested implement movement in a direction toward ground surface 18. For example, at T₄, an operator of machine 10 may quickly move operator interface device 98 in the fore direction indicating the operator's desire to rapidly lower the loaded implement 14 toward ground surface 18. At T₄, controller 58 may control the total torque output by power source 16 to decrease as shown at section D of the total torque curve. In particular, the request for rapid movement of loaded implement 14 at T₄ may result in a corresponding rapid decrease in loading on hydraulic pump 52. To account for such change in loading, and to avoid overspeeding power source 16, controller 58 may begin determining, at T₄, transient and steady state lift torques, in a closed-loop manner, as described above with respect to FIG. 3.

As shown with respect to section D of the total torque curve in FIG. 4, controller 58 may decrease power source torque based on, for example, transient lift torques determined in a closed-loop manner, until determining that a desired rate of implement movement associated with the operator's request decreases. For example, controller 58 may determine that the desired rate of implement movement, in the direction toward ground surface 18, decreases based on a decrease in the velocity of operator interface device movement in the fore direction. Such a decrease in the desired rate of implement movement may occur at T₅.

Upon determining a decrease in the desired rate of implement movement at T₅, controller 58 may maintain power source torque output substantially constant similar to section B of the total torque curve described above. Alternatively, as shown in FIG. 4, in response to determining both a decrease in the desired rate of implement movement and a steady state torque below a third threshold, controller 58 may increase power source output torque. As shown at section E of the total torque curve shown in FIG. 4, controller 58 may continue to increase power source torque output until the steady state torque decreases to a fourth threshold less than the third threshold illustrated in FIG. 4.

As shown at section F of the total torque curve, controller 58 may maintain power source torque output substantially constant in response to determining that the steady state torque is less than the fourth threshold. Such a substantially constant power source torque output may begin at T₆, and controller 58 may maintain power source torque output substantially constant until a determined transient toque is substantially equal to zero. When such a transient torque is substantially equal to zero at section F, the total torque output by power source 16 may be substantially equal to the steady state torque.

Machines employing the components and/or control methods described herein may exhibit improved responsiveness and stability to variations in load. Specifically, controlling output torque of power source 16 according to the methods described herein may assist in accommodating various changes in loading on hydraulic pump 52. In addition, since the methods described herein assist in providing fuel to power source 16 prior to transmission of such changes in loading to power source 16, power source lugging and overspeed can be reduced if not altogether eliminated.

It will be apparent to those skilled in the art that various modifications and variations can be made to the disclosed embodiments. Other embodiments will be apparent to those skilled in the art from consideration of the specification and practice of the disclosed methods. It is intended that the specification and examples be considered as exemplary only, with a true scope being indicated by the following claims and their equivalents.

What is claimed is:

1. A method of controlling a power source of a machine having an implement, comprising:
receiving a request from an operator of the machine indicative of a desired movement of the implement, wherein the desired movement will require a corresponding change in loading on a hydraulic pump associated with the implement;
determining a steady state torque that will be required to satisfy the request;
determining a transient torque that will be required to satisfy the request, wherein the transient torque is based on a desired rate of implement movement associated with the request;
generating a power source fueling signal based on the steady state torque and the transient torque, wherein the fueling signal corresponds to a total torque required to satisfy the change in loading on the hydraulic pump; and
providing fuel to the power source based on the fueling signal prior to transmission of the change in loading on the hydraulic pump to the power source.

2. The method of claim 1, wherein the request is indicative of a desired implement lift, and determining the steady state torque comprises determining a flow request based on a position of an operator interface device.

3. The method of claim 2, wherein the transient torque is based on at least one of the flow request and a position change rate associated with the operator interface device.

4. The method of claim 1, wherein determining the transient torque comprises determining a mechanical delay associated with providing fuel to the power source based on the fueling signal, and wherein the transient torque is determined based on the mechanical delay.

5. The method of claim 4, wherein the mechanical delay comprises a length of time between providing fuel to the power source based on the fueling signal and the power source providing torque sufficient to satisfy the change in loading.

6. The method of claim 4, wherein determining the transient torque comprises determining an electronic delay associated with providing fuel to the power source based on the fueling signal,
wherein the electronic delay comprises a length of time between generating the fueling signal and providing fuel to the power source based on the fueling signal, and
wherein the transient torque is determined based on the electronic delay.

7. The method of claim 1, further including determining additional transient torques in a closed-loop manner, and
increasing power source torque based on the additional transient torques until determining that the desired rate of implement movement decreases, wherein the request is indicative of implement movement in a direction away from a ground surface on which the machine is located.

8. The method of claim 7, further including maintaining power source torque substantially constant in response to determining that
a) the desired rate of implement movement decreases and
b) the steady state torque is greater than a first threshold.

9. The method of claim 8, further including decreasing, in response to determining that the steady state torque is greater than a second threshold greater than the first threshold, power source torque until at least one of the additional transient torques is substantially equal to zero.

10. The method of claim 1, further including determining additional transient torques in a closed-loop manner, and
decreasing power source torque based on the additional transient torques until determining that the desired rate of implement movement decreases, wherein the request is indicative of implement movement in a direction toward a ground surface on which the machine is located.

11. The method of claim 1, wherein generating the power source fueling signal comprises determining an anticipated change in power source loading that will be caused by the change in loading on the hydraulic pump, and
providing fuel to the power source, prior to transmission of the change in loading on the hydraulic pump to the power source, based on the anticipated change in power source loading.

12. A method of controlling a power source of a machine having an implement, comprising:
determining a plurality of operating characteristics of the machine in a closed-loop manner, the plurality of operating characteristics comprising a desired rate of implement movement and a corresponding change in loading on a hydraulic pump associated with the implement;
determining, based on the plurality of operating characteristics, that at least one of implement lift and implement tilt is desired by an operator of the machine;
determining a steady state torque and a transient torque corresponding to the desired at least one of implement lift and implement tilt, wherein the transient torque is determined based on the desired rate of implement movement;
determining, based on the steady state torque and the transient torque, a total torque required to satisfy the change in loading on the hydraulic pump; and
providing fuel to the power source based on the determined total torque prior to transmission of the change in loading on the hydraulic pump to the power source.

13. The method of claim 12, wherein determining the plurality of operating characteristics comprises determining
a) a flow request indicative of the change in loading on the hydraulic pump, and
b) a position change rate associated with an operator interface device operably connected to the implement.

14. The method of claim 13, further including determining an anticipated change in power source loading that will be caused by the change in loading on the hydraulic pump, and
providing fuel to the power source, prior to transmission of the change in loading on the hydraulic pump to the power source, based on the anticipated change in power source loading.

15. The method of claim 12, further including determining that implement lift and implement tilt are both desired, wherein
determining the steady state torque comprises determining a steady state tilt torque and a steady state lift torque, and
determining the transient torque comprises determining a transient tilt torque and a transient lift torque.

16. The method of claim 12, further including generating a plurality of power source fueling signals, in a closed-loop manner, based on the plurality of operating characteristics, and providing fuel to the power source based on the plurality of fueling signals, wherein
the plurality of fueling signals sequentially increase power source torque until
a) the desired rate of implement movement decreases and
b) the steady state torque is greater than a first threshold, and wherein
the plurality of power source fueling signals sequentially decrease power source torque once the steady state torque is greater than a second threshold greater than the first threshold.

17. The method of claim 16, wherein the plurality of power source fueling signals decrease power source torque until the transient torque is substantially equal to zero.

18. A machine, comprising:
a power source;
an implement;
a hydraulic pump driven by the power source and operably connected to the implement; and
a controller in communication with the power source and the hydraulic pump, the controller being configured to
receive a request from an operator of the machine indicative of a desired movement of the implement, wherein the desired movement will require a corresponding change in loading on the hydraulic pump,
determine a steady state torque that will be required to satisfy the request,
determine a transient torque that will be required to satisfy the request, wherein the transient torque is based on a desired rate of implement movement associated with the request,
determine, based on the steady state torque and the transient torque, a total torque required to satisfy the change in loading on the hydraulic pump, and
modify power source fueling, based on the total torque, prior to transmission of the change in loading on the hydraulic pump to the power source.

19. The machine of claim 18, further including an operator interface device associated with the implement and in communication with the controller, wherein the request is received via the operator interface device and the transient torque is determined based on a position change rate associated with the operator interface device.

20. The machine of claim 19, further including a sensor in communication with the controller and configured to determine at least one of a position of the operator interface device and the position change rate associated with the operator interface device.
